(19) United States
(12) Patent Application Publication
(10) Pub. No.: US 2025/0308045 A1
(43) Pub. Date: Oct. 2, 2025

(54) MODEL LEARNING METHOD AND SYSTEM CAPABLE OF SENSOR-AGNOSTIC DEPTH MAP INFERENCE THROUGH DEPTH PROMPTING, AND DEPTH MAP INFERENCE METHOD AND SYSTEM USING THE SAME

(71) Applicant: GWANGJU INSTITUTE OF SCIENCE AND TECHNOLOGY, Gwangju (KR)

(72) Inventors: Hae Gon JEON, Gwangju (KR); Jin Hwi PARK, Gwangju (KR); Chan Hwi JEONG, Gwangju (KR); Jun Oh LEE, Gwangju (KR)

(73) Assignee: GWANGJU INSTITUTE OF SCIENCE AND TECHNOLOGY, Gwangju (KR)

(21) Appl. No.: 19/002,363

(22) Filed: Dec. 26, 2024

(30) Foreign Application Priority Data
Mar. 26, 2024 (KR) 10-2024-0041415

(51) Int. Cl. G06T 7/50

(52) U.S. Cl. CPC G06T 7/50; G06T 2207/20081

(57) ABSTRACT

A model learning method capable of sensor-agnostic depth map inference is provided. The model learning method includes receiving a training image and a ground truth depth map, generating a sparse depth map for training corresponding to the ground truth depth map, generating, using a first model provided to predict a depth map, a first feature and a first depth map corresponding to the training image, substituting the first depth map, which is a relative depth map acquired from the first model, with an absolute depth map reflecting the sparse depth map for training, generating, using a second model provided to perform prompt encoding, a second depth map corresponding to the sparse depth map for training, the first feature, and the first depth map, and training the second model so that the second depth map simulates the ground truth depth map.

### DESCRIPTION OF GOVERNMENT-SPONSORED RESEARCH

The present invention was carried out with support from the national research and development project, with the unique project identification number being 1415183637 and the project number being P0019797. The project related to the present invention is supervised by the Ministry of Trade, Industry and Energy, and managed by the Korea Institute for Advancement of Technology (KIAT). The research program is titled “Industrial Technology International Cooperation Project,” and the research project is named “Development of a User-Participatory Metaverse Performance Solution Based on Neural Human Modeling.” The project executing institution is WYSIWYG Studios Co., Ltd., and the research period is from Dec. 1, 2021, to Nov. 30, 2024.

### CROSS REFERENCE TO RELATED APPLICATION

The present application claims priority to Korean Patent Application No. 10-2024-0041415, filed on Mar. 26, 2024, the entire contents of which is incorporated herein for all purposes by this reference.

### BACKGROUND

### Field

The present invention relates to a model learning method and system capable of sensor-agnostic depth map inference through depth prompting, an a depth map inference method and system using the same.

In addition, the present invention was carried out with support from the national research and development project, with the unique project identification number being 1711197190 and the project number being 2022-DD-UP-0312-02. The project related to the present invention is supervised by the Ministry of Science and ICT, and managed by (Foundation) the Korea Innovation Foundation (INNOPOLIS). The research project is titled “Regional Research and Development Innovation Support Project,” and the research project is named “Convergent Cultural Virtual Studio for AI-Based Metaverse Implementation.” The project executing institution is Gwangju Institute of Science and Technology, and the research period is from Apr. 1, 2022, to Dec. 31, 2026.

In addition, the present invention was carried out with support from the national research and development project, with the unique project identification number being 1711196775 and the project number being S1602-20-1001. The project related to the present invention is supervised by the Ministry of Science and ICT, and managed by the National IT Industry Promotion Agency (NIPA). The research program is titled “AI-Centered Industrial Convergence Cluster Development (R&D) Project,” and the research project is named “Development of Customized Autonomous Driving Software Platform Technology for Specific-Purpose Vehicles.” The project executing institution is Autonomous a2z Co., Ltd., and the research period is from Apr. 1, 2020, to Dec. 31, 2024.

In addition, the present invention was carried out with support from the national research and development project, with the unique project identification number being 1711139517 and the project number being 2021-0-02068-001. The project related to the present invention is supervised by the Ministry of Science and ICT, and managed by the Institute of Information and Communications Technology Planning and Evaluation (IITP). The research program is titled “ICT Broadcasting Innovation Talent Development (R&D) Project,” and the research project is named “Research and Development of AI Innovation Hub.” The project executing institution is Korea University, and the research period is from Jul. 1, 2021, to Dec. 31, 2025.

In addition, the present invention was carried out with support from the national research and development project, with the unique project identification number being 1711193897 and the project number being 2019-0-01842-005. The project related to the present invention is supervised by the Ministry of Science and ICT, and managed by the Institute of Information and Communications Technology Planning and Evaluation (IITP). The research program is titled “ICT Broadcasting Innovation Talent Development Project,” and the research project is named “AI Graduate School Support (GIST).” The project executing institution is Gwangju Institute of Science and Technology, and the research period is from Sep. 1, 2019, to Dec. 31, 2023.

### DESCRIPTION OF RELATED ART

The depth of a scene is used as one of the key elements in various visual recognition tasks, such as 3D object detection, operation recognition, and augmented reality. Accordingly, various studies have been conducted to acquire an accurate depth map for a specific scene in the related art.

In particular, with the advancement of deep learning technology, it has become easier to predict a depth map from scene images using models trained on learning data, and depth map prediction using a single image captured by a monocular camera has also become possible.

However, such conventional methods often yield relatively inaccurate results for images that deviate from the distribution based on the training dataset or the camera parameters.

To this end, methods of capturing depth maps in real time using active sensors such as light detection and ranging (LiDAR), time of flight (ToF), and multi-channel structured light is being researched.

However, while these methods allow for real-time acquisition of depth maps from a single image, it is only feasible to acquire sparse depth maps with relatively fewer depth values.

### SUMMARY

The present invention relates to a model learning method and system capable of sensor-agnostic depth map inference through depth prompting, a depth map inference method and system using the same.

In addition, the present invention relates to a model learning method and system for overcoming various biases that occur during the process of generating a depth map, and implementing a model capable of sensor-agnostic depth map inference, as well as a depth map inference method and system using the same.

In addition, the present invention relates to a model learning method and system for inferring a depth map that considers both actual spatial shapes and depth information measured by a sensor, as well as a depth map inference method and system using the same.

In addition, the present invention relates to a model learning method and system for predicting a depth map corresponding to an image and a sparse depth map captured based on various types of sensors, as well as a depth map inference method and system using the same.

To solve the aforementioned objects, there is provided a model learning method capable of sensor-agnostic depth map inference, according to the present invention. The model learning method may include: receiving a training image and a ground truth depth map corresponding to the training image; extracting a predetermined number of depth values from the ground truth depth map to generate a sparse depth map for training corresponding to the ground truth depth map; generating, using a first model pre-provided to predict a depth map from an image, a first feature and a first depth map corresponding to the training image; generating, using a second model pre-provided to perform prompt encoding, a second depth map corresponding to the sparse depth map for training, the first feature, and the first depth map; and training the second model so that the second depth map simulates the ground truth depth map.

In addition, there is provided a model learning system capable of sensor-agnostic depth map inference, according to the present invention. The model learning system may include: a communication unit configured to receive a training image and a ground truth depth map corresponding to the training image; and a control unit configured to train a depth map inference model using the training image and the ground truth depth map, in which the depth map inference model may include a first model and a second model, and the control unit may extract a predetermined number of depth values from the ground truth depth map to generate a sparse depth map for training corresponding to the ground truth depth map, generate, using the first model, pre-provided to predict a depth map from an image, a first feature and a first depth map corresponding to the training image, generate, using the second model, pre-provided to perform prompt encoding, a second depth map corresponding to the sparse depth map for training, the first feature, and the first depth map, and train the second model so that the second depth map simulates the ground truth depth map.

In addition, there is provided a program stored on a computer-readable recording medium, and executed by one or more processes in an electronic device, according to the present invention. The program may include instructions to allow the program to perform: receiving a training image and a ground truth depth map corresponding to the training image; extracting a predetermined number of depth values from the ground truth depth map to generate a sparse depth map for training corresponding to the ground truth depth map; generating, using a first model pre-provided to predict a depth map from an image, a first feature and a first depth map corresponding to the training image; generating, using a second model pre-provided to perform prompt encoding, a second depth map corresponding to the sparse depth map for training, the first feature, and the first depth map; and training the second model so that the second depth map simulates the ground truth depth map.

In addition, there is provided a depth map inference method using a depth map inference model that includes a first model and a second model, according to the present invention. The depth map inference method may include: receiving an image and a sparse depth map corresponding to the image; generating, using the first model, pre-provided to predict a depth map from an image, a first feature and a first depth map corresponding to the image; generating, using the second model, pre-trained to perform prompt encoding, a second depth map corresponding to the sparse depth map, the first feature, and the first depth map; and providing the second depth map as a depth map corresponding to the image.

In addition, there is provided a depth map inference system, according to the present invention. The depth map inference system may include: an input unit configured to receive an image and a sparse depth map corresponding to the image; and a control unit configured to generate a depth map corresponding to the image and the sparse depth map using a pre-trained depth map inference model, in which the depth map inference model may include a first model and a second model, and the control unit may generate, using the first model, pre-provided to predict a depth map from the image, a first feature and a first depth map corresponding to the image, generate, using the second model, pre-trained to perform prompt encoding, a second depth map corresponding to the sparse depth map, the first feature, and the first depth map, and provide the second depth map as the depth map corresponding to the image.

In addition, there is provided a program stored on a computer-readable recording medium, and executed by one or more processes in an electronic device, according to the present invention. The program may include instructions to allow the program, in a depth map inference method using a depth map inference model that includes a first model and a second model, to perform: receiving an image and a sparse depth map corresponding to the image; generating, using the first model, pre-provided to predict a depth map from an image, a first feature and a first depth map corresponding to the image; generating, using the second model, pre-trained to perform prompt encoding, a second depth map corresponding to the sparse depth map, the first feature, and the first depth map; and providing the second depth map as a depth map corresponding to the image.

According to various embodiments of the present invention, the model learning method and system capable of sensor-agnostic depth map inference through depth prompting, and the depth map inference method and system using the same, may generate a sparse depth map for training with a random pattern from a dense depth map, and use this to train a depth map inference model that includes a prompt encoder. This allows the system to overcome biases caused by insufficient training data, biases due to patterns in the sparse depth maps measured by sensors, and biases due to measurement range limitations of the sensors, thereby implementing a model capable of sensor-agnostic depth map inference.

That is, the model learning method and system capable of sensor-agnostic depth map inference through depth prompting, and the depth map inference method and system using the same, may extract features of an image through the base model included in the depth map inference model, fuse the sparse depth map with the image features through the prompt model included in the depth map inference model, and train the depth map inference model to infer a depth map on the basis of this fusion. Therefore, the system may infer a depth map in which both the actual spatial shapes and the depth information measured by the sensor are considered together.

In addition, according to various embodiments of the present invention, the model learning method and system capable of sensor-agnostic depth map inference through depth prompting, and the depth map inference method and system using the same, may use a depth map inference model trained to be independent of the sensor type to predict a depth map corresponding to an image and a sparse depth map captured based on various types of sensors.

### BRIEF DESCRIPTION OF THE DRAWINGS

FIG. 1 and FIG. 2 illustrate an embodiment of a depth map inference model.

FIG. 3 illustrates a model learning system according to the present invention.

FIG. 4 illustrates a depth map inference system according to the present invention.

FIG. 5 is a flowchart illustrating a model learning method according to the present invention.

FIG. 6 illustrates an embodiment for generating a sparse depth map for training.

FIG. 7 and FIG. 8 illustrate an embodiment in which a base model generates an initial depth map.

FIG. 9 illustrates an embodiment in which a prompt model is used to generate a similarity map.

FIG. 10 to FIG. 12 illustrate an embodiment in which a prompt model is used to generate a depth map.

FIG. 13 illustrates an embodiment for calculating the loss of a depth map inference model.

FIG. 14 is a flowchart illustrating a depth map inference system according to the present invention.

FIG. 15 illustrates an embodiment in which a depth map inference model is used to infer a depth map.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

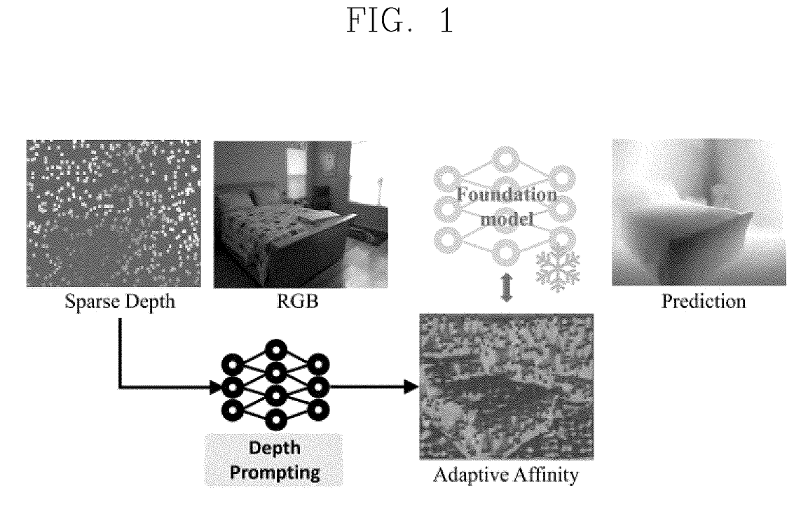

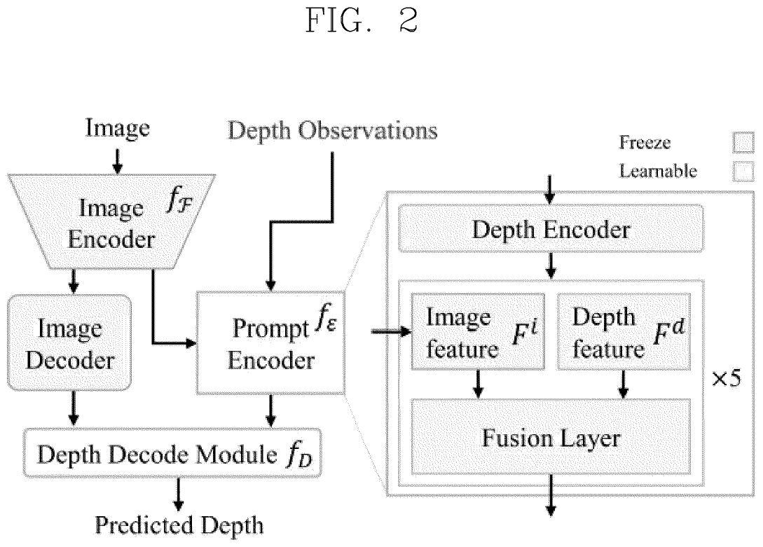

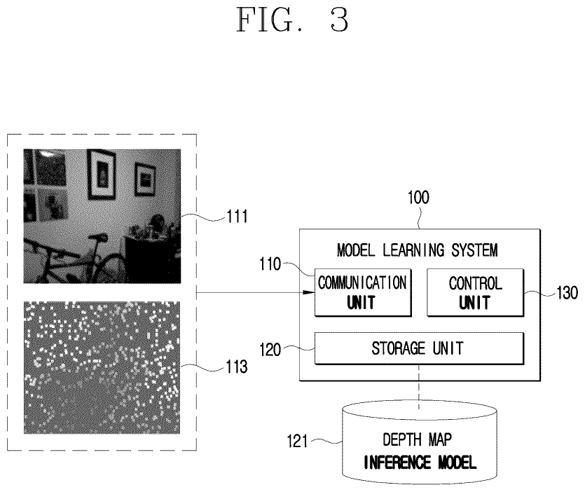

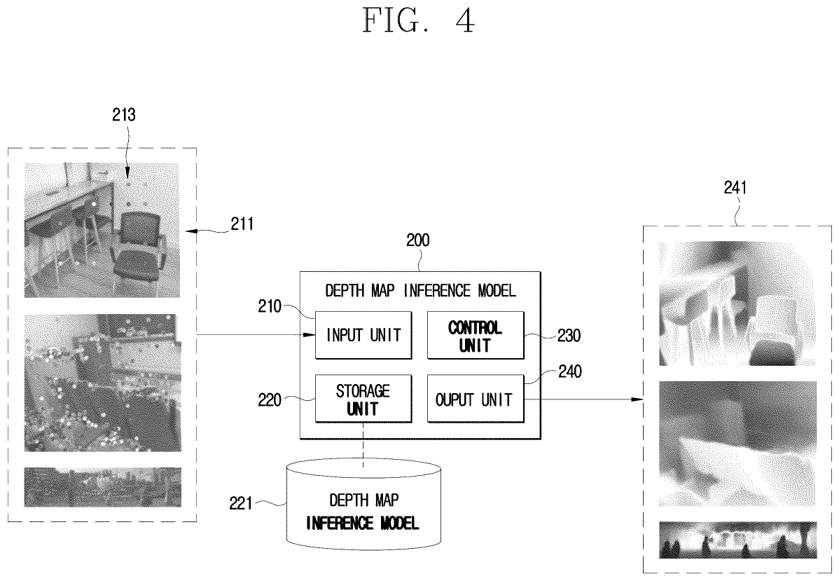

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. FIG. 1 and FIG. 2 illustrate an embodiment of a depth map inference model. FIG. 3 illustrates a model learning system according to the present invention. FIG. 4 illustrates a depth map inference system according to the present invention.

With reference to FIG. 1 and FIG. 2, a model learning system 100 according to the present invention may train a depth map inference model to infer a dense depth map (e.g., prediction) on the basis of an image (e.g., RGB) and a sparse depth map corresponding to the image (e.g., sparse depth map).

To this end, the model learning system 100 may receive training images and ground truth depth maps, generate a sparse depth map for training using the ground truth depth map, and train the depth map inference model using the training images, sparse depth map for training, and ground truth depth map.

Here, the training image is an image used to generate a dense depth map on the basis of the sparse depth map, and may be either a color or grayscale image captured through a camera.

For example, the training image may include an RGB image, a CMYK image, and the like, and may be an image captured by a monocular camera.

The ground truth depth map is a dense depth map, which may be generated using light detection and ranging (LiDAR), time of flight (ToF), multi-channel structured light, and the like. Such a ground truth depth map (or dense depth map) may a map in which depth values for each position are measured for the same space (or scene) as the training image.

The sparse depth map for training may be generated on the basis of the ground truth depth map in a manner that corresponds to a sparse depth map. Accordingly, the sparse depth map for training may be generated to correspond to the image corresponding to the ground truth depth map.

In this case, the sparse depth map, compared to the dense depth map, may be a depth map including depth values with lower density. Such a sparse depth map may be a depth map measured using a sensor mounted on (or on one side of) a monocular camera, and include depth values in the form of a point cloud measured in a predetermined pattern for the corresponding sensor.

In this regard, the sparse depth map may have depth values measured in different patterns depending on the type and form of the sensor mounted on (or on one side of) the monocular camera.

Accordingly, the sparse depth map for training may be generated by extracting a plurality of depth values corresponding to an arbitrary pattern from the ground truth depth map.

Depending on the embodiment, the sparse depth map for training may also be generated by extracting a predetermined number of depth values from random positions within the ground truth depth map.

That is, the sparse depth map for training may be generated by performing sampling on the ground truth depth map.

The depth map inference model may be, when an image and a sparse depth map are input, implemented to infer (or predict) and output a depth map (e.g., a dense depth map) corresponding to the input image and sparse depth map.

To this end, the depth map inference model may include a base model (or first model) and a prompt model (or second model).

The base model may be pre-trained to predict an initial depth map (or first depth map) from an image. When an image is input, the base model may be trained to calculate an image feature vector (or first feature) for the input image and generate an initial depth map on the basis of the calculated image feature vector.

The base model may be pre-trained using training data consisting of image and depth map pairs. For example, the base model may be trained to generate a depth map corresponding to an input image when the image is input.

Alternatively, the base model may use a model trained on a large-scale training dataset. For example, the base model may be a natural language processing (NLP) model trained on a large-scale dataset. In this case, a template may be provided to predict the depth map from an image. Therefore, the base model may receive an image as input on the basis of the template and predict and output the corresponding depth map corresponding to the image.

In addition, the base model may a model that is implemented as an encoder-decoder model. When an image is input, the base model may use the encoder to compress the image, thereby generating an image feature vector corresponding to the image.

In this case, the base model may be implemented such that a plurality of encoders and a plurality of decoders correspond to each other. In this case, the image may be compressed step-by-step through the plurality of encoders.

In this regard, the image feature vector may be output from a last encoder among the plurality of encoders. For example, the image feature vector may be multi-scale intermediate features.

The base model may generate an initial depth map corresponding to an image by restoring the image feature vector using the decoder. In this case, when a plurality of decoders are included, the base model may restore the image feature vector step-by-step to generate an initial depth map. In this case, the plurality of feature vectors output from each of the plurality of encoders may be input to the decoders corresponding to respective encoders via skip connections.

With reference to Equation 1 below, the image feature vector and initial depth map generated on the basis of the base model can be confirmed.

$${\hat{D}}_{I} , {F}_{k}^{i} = {f}_{F} ( I , {Θ}_{{f}_{F}} ) \qquad Equation 1$$

$$I ∈ {R}^{3 \times H \times W}$$

Here, \hat{D}_{I} may represent an initial depth map, Fₖⁱ refers to multi-scale intermediate features output from an encoder of an initial model, which may be understood as an image feature vector, f_{F} f_{F} may represent a base model, Θf_{F} may indicate parameters of a pre-trained base model, and “I” may be an image input to the base model (e.g., training image). In this case, “I” may be an image composed of RGB channels.

Meanwhile, the prompt model may use a model trained on large-scale language data. For example, the base model may be a natural language processing model or a large language model (LLM) trained on large-scale language data.

Accordingly, the prompt model may be a model that is implemented as an encoder-decoder model. When a sparse depth map is input, the prompt model may use the encoder to compress the previously input sparse depth map, thereby generating a prompt embedding vector (or second feature) and a depth map feature vector (or third feature) corresponding to the input sparse depth map.

In an embodiment, the prompt embedding vector may be a conversion of the sparse depth map to be processable by the prompt model, while the depth map feature vector is a compression of the prompt embedding vector using the encoder of the prompt model, for example, may be multi-scale features.

In addition, the prompt model may include a plurality of encoders, and in this case, the prompt embedding vector may be compressed step-by-step through the plurality of encoders. For example, the prompt model may include a plurality of encoders that perform down-sampling at ratios of 1/2, 1/4, 1/8, 1/16, and 1/32.

With reference to Equation 2 below, the prompt embedding vector and depth map feature vector generated on the basis of the encoder of the prompt model can be confirmed.

$${F}^{d} , {F}_{k}^{d} = {f}_{ε} ( {D}_{S} ) \qquad Equation 2$$

Here, F^{d} may represent a prompt embedding vector, Fₖ^{d} may be a depth map feature vector, f_{ε} may represent an encoder of a prompt model, and D_{S} may indicate a sparse depth map.

Meanwhile, the encoder of the prompt model may include a fusion layer. The fusion layer may be implemented to fuse the image feature vector generated from the encoder of the base model with the prompt embedding vector and the depth map feature vector generated from the encoder of the prompt model, in order to generate a similarity map (affinity map) corresponding to the sparse depth map.

To this end, the encoder of the prompt model may be implemented to receive the image feature vector from the encoder of the base model as input along with the sparse depth map, and may be implemented to output a similarity map corresponding to the sparse depth map and the image feature vector.

In this case, the similarity map may be a grouping of regions with similar features (or vector values), based on a series of regularities observed from the image feature vector, prompt embedding vector, and depth map feature vector.

With reference to Equation 3 below, the similarity map generated on the basis of the fusion layer included in the encoder of the prompt model can be confirmed.

$${A}_{ada} = {f}_{D} ( {F}^{d} , {F}_{k}^{d} , {F}_{k}^{i} ) \qquad Equation 3$$

$${A}_{ada} ∈ {R}^{{C}^{2} \times H \times W}$$

Here, A_{ada} may represent a similarity map, f_{D} may denote a fusion layer, and “C” may represent an extent of spatial propagation performed in the decoder of the prompt model.

In addition, the prompt model may use the decoder to infer a final depth map (or second depth map), which is a dense depth map corresponding to the initial depth map output from the base model, as well as the sparse depth map and similarity map output from the encoder of the prompt model.

To this end, the decoder of the prompt model may be implemented to receive the initial depth map, sparse depth map, and similarity map as input, and output a dense depth map corresponding to the initial depth map, sparse depth map, and similarity map.

Specifically, the decoder of the prompt model may generate a first final depth map (or third depth map) on the basis of the initial depth map and sparse depth map, and then generate a second final depth map (or fourth depth map) on the basis of the similarity map and the previously generated first final depth map.

In this case, the decoder of the prompt model may be implemented to perform spatial propagation for the final depth map on the basis of the similarity map, thereby inferring a dense depth map.

Accordingly, the decoder of the prompt model may, after generating the second final depth map on the basis of the similarity map and the first final depth map, repeat the process of generating a new second final depth map on the basis of the similarity map, the first final depth map, and the second final depth map according to a predetermined spatial propagation step.

Therefore, the prompt model may infer a dense depth map (e.g., final depth map) corresponding to the image feature map and the sparse depth map. Accordingly, depending on the embodiment, the second final depth map (or fourth depth map) may be generated identically to the final depth map (or second depth map) output from the depth map inference model (or prompt model).

With reference to Equations 4 and 5 below, the first final depth map generated on the basis of the decoder of the prompt model can be confirmed.

$$\hat{p} = {min}_{p} {‖ p {\hat{D}}_{I}^{V} - {D}_{S} ‖}_{F} \qquad Equation 4$$

$${\hat{D}}_{I}^{V} ⊂ {\hat{D}}_{I}$$

Here, ∥·∥_{F} may represent the Frobenius norm to calculate a distance between two matrices, DI may represent one or more depth values from a plurality of depth values belonging to an initial depth map that correspond to a sparse depth map input to the prompt model, “p” may be a first variable of the least-square equation, and P may be a second variable of the least-square equation.

$${D}_{( x , y )}^{0} = \hat{p} \times {\hat{D}}_{I} \qquad Equation 5$$

Here, D_{(x,y)}⁰ may represent a first final depth map.

Accordingly, the decoder of the prompt model may calculate the first and second variables that minimize a difference between the sparse depth map and the initial depth map output from the base model, and then calculate the first final depth map using the calculated second variable and the initial depth map.

In this case, the initial depth map may be understood as a relative depth map acquired from the base model on the basis of a given image (e.g., training image), while the first final depth map may be understood as an absolute depth map substituted from the relative depth map, reflecting the sparse depth map for training.

Subsequently, with reference to Equation 6 below, the second final depth map generated on the basis of the decoder of the prompt model can be confirmed.

$${D}_{( x , y )}^{t + 1} = A ( x , y ) ⊙ {D}_{( x , y )}^{0} + {\sum }_{( l , m ) ∈ {N}_{( x , y )}} A ( l , m ) ⊙ {D}_{( l , m )}^{t} \qquad Equation 6$$

$${D}_{( x , y )}^{t} ∈ {R}^{1 \times H \times W}$$

$$( l , m ) ∈ {N}_{( x , y )}$$

Here, D_{(x,y)}^{t+1} may represent a second final depth map, (operator may denote an element-wise multiplication, (x, y) may represent pixel coordinates (or spatial coordinates) of a final depth map, N_{(x, y)} may represent eight neighboring pixels adjacent to a specific pixel of the final depth map, and (l, m) may represent pixel coordinates (or spatial coordinates) of the neighboring pixels.

Meanwhile, the model learning system 100 may train the depth map inference model by inputting the training image and sparse depth map for training into the depth map inference model, and using the final depth map output and the ground truth depth map.

To this end, the model learning system 100 may input the training image and sparse depth map for training into the depth map inference model, then calculate the loss (or first loss) of the prompt model on the basis of the final depth map output (e.g., second final depth map) and the ground truth depth map, and subsequently train the prompt model on the basis of the calculated loss.

In this case, the model learning system 100 may be implemented to train only the prompt model while keeping the parameters of the base model fixed. In addition, the prompt model may be trained by considering both the loss of the prompt model and the scale-invariant loss (or second loss) of the base model.

With reference to Equations 7 to 9 below, the loss used to train the prompt model can be confirmed.

$${L}_{SI} ( {\hat{D}}_{I} , {D}^{gt} ) = \frac{1}{\vert V \vert} {\sum }_{v ∈ V} {( {δ}_{v} )}^{2} - \frac{λ}{{\vert V \vert}^{2}} {( {\sum }_{v ∈ V} {δ}_{v} )}^{2} \qquad Equation 7$$

$${δ}_{v} = log {\hat{D}}_{I} ( v ) - log {D}^{gt} ( v )$$

Here, L_{SI} may represent a scale-invariant loss for the base model, D^{gt} may denote a ground truth depth map, which is an actual depth map, “V” may represent a set of valid pixels in an initial depth map, “v” may represent each valid pixel in the initial depth map, δᵥ δᵥ, may be a first parameter for the scale-invariant loss, and λ may be a second parameter for the scale-invariant loss.

In this case, the second parameter for the scale-invariant loss may be a predetermined value, and in an embodiment, may be set to 0.85.

$${L}_{c o m b} ( \hat{D} , {D}^{gt} ) = \frac{1}{\vert V \vert} {\sum }_{v ∈ V} ( \vert \hat{D} ( v ) - {D}^{gt} ( v ) \vert + {\vert \hat{D} ( v ) - {D}^{gt} ( v ) \vert}^{2} ) \qquad Equation 8$$

Here, L_{comb} may represent a loss for the prompt model, \hat{D} may represent a final depth map (or second final depth map) output from the depth map inference model (or prompt model), “V” may represent a set of valid pixels in the final depth map, and “v” may represent each valid pixel in the final depth map.

$$L = {L}_{c o m b} ( \hat{D} , {D}^{gt} ) + μ {L}_{SI} ( \hat{D} , {D}^{gt} ) \qquad Equation 9$$

Here, “L” may represent a loss (or third loss) of the depth map inference model based on the loss of the prompt model and the scale-invariant loss of the base model. μ may be a predetermined parameter for the loss of the prompt model and the scale-invariant loss of the base model, and in an embodiment, the parameter may be set to 0.1.

With the configuration as described above, the model learning system 100 may use the depth map inference model to predict a final depth map corresponding to the training image and sparse depth map for training, compare the predicted final depth map with the ground truth depth map, and calculate the loss for the depth map inference model. The depth map inference model may then be trained to minimize the calculated loss for the depth map inference model.

Meanwhile, with reference to FIG. 3, the model learning system 100 may include a communication unit 110, a storage unit 120, and a control unit 130.

The communication unit 110 may be connected to an external server or external device via a wireless or wired network, and accordingly, may receive a training image 111 and a ground truth depth map 113 from the external server or external device.

In addition, the communication unit 110 may receive a depth map inference model 121 and information related to the depth map inference model 121 from an external server or external device, and may also transmit information generated during the training process of the depth map inference model 121, as well as the depth map inference model 121 that has been trained, to the external server or external device.

The storage unit 120 may store data and commands necessary for the operation of the model learning system 100 according to the present invention.

For example, the storage unit 120 may store the depth map inference model 121 and information related to the depth map inference model 121, as well as store the training image 111 and ground truth depth map 113.

In addition, the storage unit 120 may store information generated during the training process of the depth map inference model 121, and it may also store the depth map inference model 121 that has been trained.

The control unit 130 may control the overall operation of the model learning system 100 according to the present invention.

For example, the control unit 130 may generate a sparse depth map for training on the basis of the ground truth depth map 113, and use the depth map inference model 121 to generate a final depth map corresponding to the training image 111 and the sparse depth map for training.

In addition, the control unit 130 may train the depth map inference model 121 using the previously generated final depth map and the ground truth depth map 113.

Meanwhile, with reference to FIG. 4, a depth map inference system 200 according to the present invention may receive an image 211 and a sparse depth map 213 corresponding to the image 211, and use a pre-trained depth map inference model 221 to generate a final depth map 241 (or second depth map) corresponding to the image 211 and the sparse depth map 213.

Here, the image 211 may be a color or grayscale image captured by a camera, and for example, may include an RGB image, a CMYK image, and the like, and may also be an image 211 captured by a monocular camera.

In addition, the sparse depth map 213 is a depth map measured using a sensor mounted on the camera (or one side of the camera) provided to capture the image 211, and may include depth values in the form of a point cloud measured in a predetermined pattern for the corresponding sensor.

Such a sparse depth map 213 may include sparse depth maps 213 with depth values measured in different patterns, depending on the type, form, etc. of the sensor.

In addition, the pre-trained depth map inference model 221 is trained to infer a dense depth map using the image 211 and the sparse depth map 213, and may be trained by the model learning system 100 described above.

That is, the pre-trained depth map inference model 221 may be trained according to the model learning method of the present invention.

Accordingly, the depth map inference system 200 may use the base model included in the depth map inference model 221 to generate an image feature vector and an initial depth map corresponding to the image 211. Further, the depth map inference system 200 may use the prompt model included in the depth map inference model 221 to generate a prompt embedding vector and a depth map feature vector corresponding to the sparse depth map 213.

Subsequently, the depth map inference system 200 may use the fusion layer of the prompt model to generate a similarity map corresponding to the image feature vector, prompt embedding vector, and depth map feature vector. Then, the depth map inference system 200 may use the decoder of the prompt model to generate the final depth map 241 corresponding to the sparse depth map 213, initial depth map, and similarity map.

To this end, the depth map inference system 200 according to the present invention may include an input unit 210, a storage unit 220, a control unit 230, and an output unit 240.

The input unit 210 may be connected to an external server or external device via a wireless or wired network, and receive the image 211 and the sparse depth map 213 corresponding to the image 211.

In this case, the external server or external device may be implemented to store the image 211 and sparse depth map 213, or may be implemented to capture the image 211 and sparse depth map 213.

The storage unit 220 may store data and commands necessary for the operation of the depth map inference system 200 according to the present invention.

For example, the storage unit 220 may store the image 211 and the sparse depth map 213, as well as the pre-trained depth map inference model 221.

In addition, the storage unit 220 may store information generated during the process of inferring the depth map through the depth map inference model 221, and it may store the depth map inferred through the depth map inference model 221 (or final depth map 241).

The control unit 230 may control the overall operation of the depth map inference system 200 according to the present invention.

For example, the control unit 230 may generate a depth map (e.g., final depth map 241) corresponding to the image 211 and the sparse depth map 213 through the depth map inference model 221.

The output unit 240 may be connected to an external server or external device via a wireless or wired network, and transmit the information generated by the control unit 230.

For example, the output unit 240 may transmit at least one of the image 211, the sparse depth map 213, or the depth map (e.g., final depth map 241) to an external server or external device implemented to store certain information. Alternatively, the output unit 240 may output at least one of the image 211, sparse depth map 213, or depth map through a display device that outputs certain information so that a user may visually identify the information.

With the configurations of the model learning system 100 and the depth map inference system 200 as described above, a more detailed description of the model learning method and the depth map inference method will be provided below.

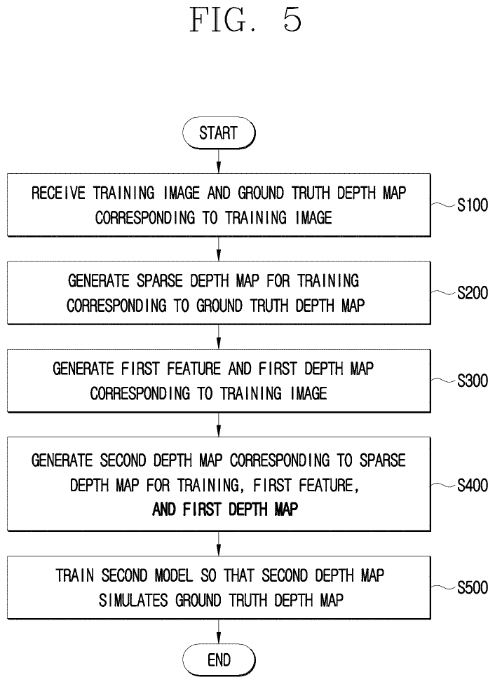

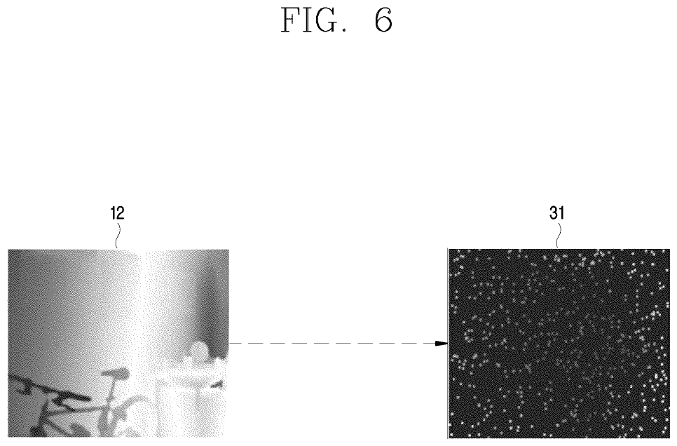

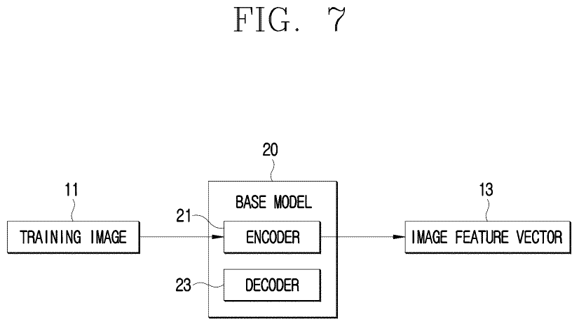

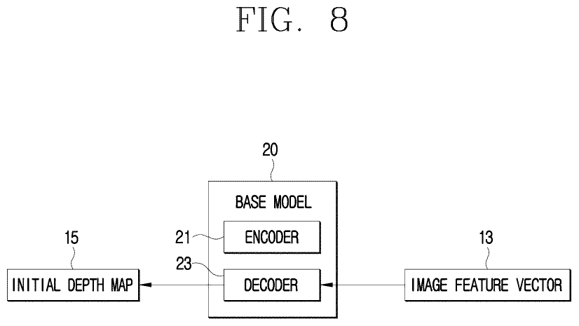

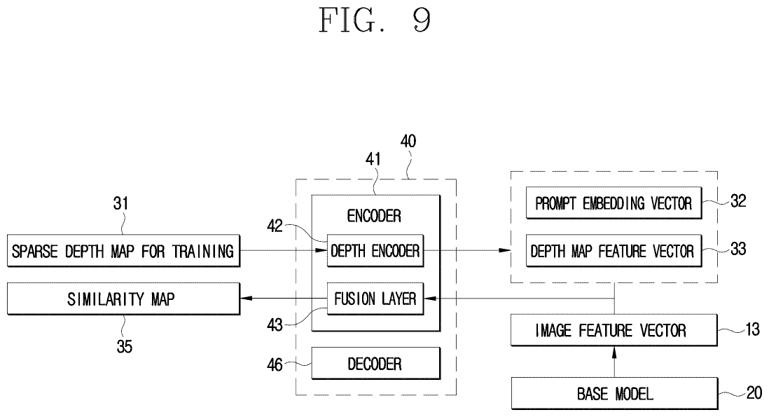

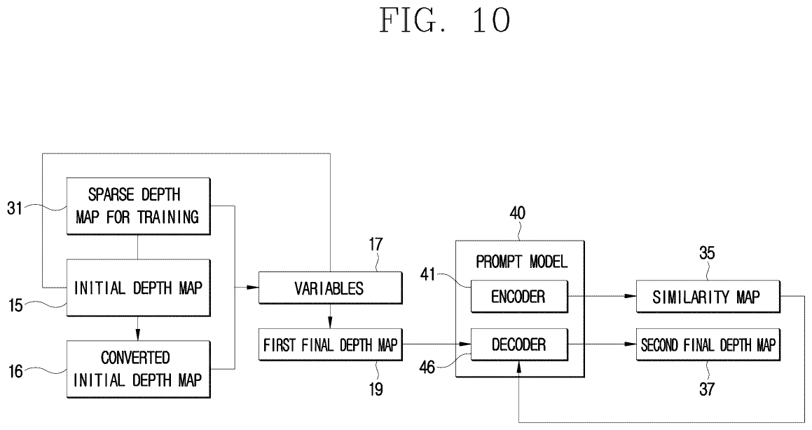

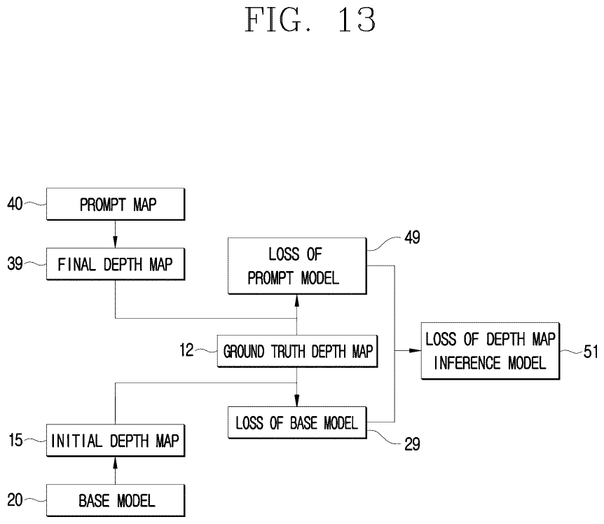

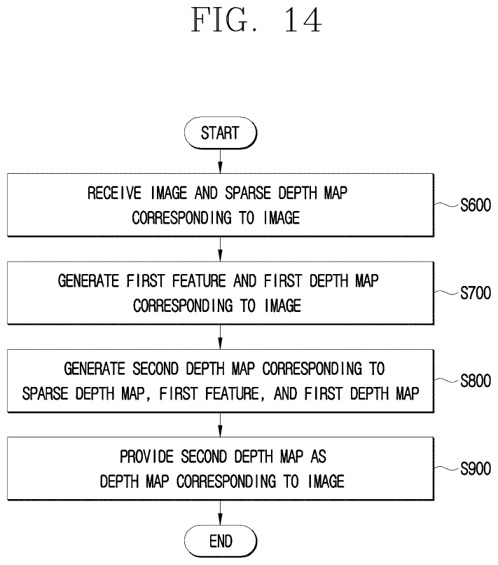

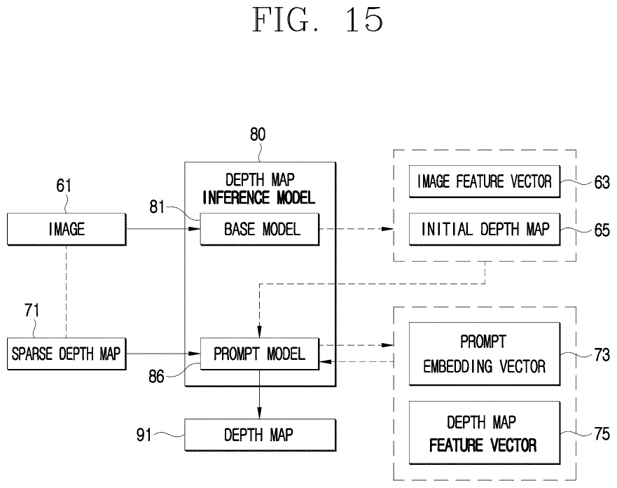

FIG. 5 is a flowchart illustrating a model learning method according to the present invention. FIG. 6 illustrates an embodiment for generating a sparse depth map for training. FIG. 7 and FIG. 8 illustrate an embodiment in which a base model generates an initial depth map. FIG. 9 illustrates an embodiment in which a prompt model is used to generate a similarity map. FIG. 10 to FIG. 12 illustrate an embodiment in which a prompt model is used to generate a depth map. FIG. 13 illustrates an embodiment for calculating the loss of a depth map inference model. FIG. 14 is a flowchart illustrating a depth map inference system according to the present invention. FIG. 15 illustrates an embodiment in which a depth map inference model is used to infer a depth map.

The model learning system 100 according to the present invention may receive a training image and a ground truth depth map corresponding to the training image (S100), and use the ground truth depth map to generate a sparse depth map for training corresponding to the ground truth depth map (S200).

Specifically, the model learning system 100 may receive a training image capturing a specific scene, along with the ground truth depth map, which is the actual depth map of the same scene. Through sampling of the ground truth depth map, the model learning system 100 may extract a predetermined number of depth values from the ground truth depth map to generate the sparse depth map for training.

With reference to FIG. 6, for example, the model learning system 100 may extract a predetermined number of depth values from the plurality of depth values included in the ground truth depth map 12. In this case, the model learning system 100 may generate the sparse depth map for training 31 by extracting the pixel coordinates and pixel values of a predetermined number of pixels randomly positioned within the ground truth depth map 12.

In another example, the model learning system 100 may specify a specific sampling value within a predetermined sampling range. In this case, the model learning system 100 may extract the number of depth values from the plurality of depth values included in the ground truth depth map that corresponds to the previously specified sampling value.

Therefore, the model learning system 100 may generate a sparse depth map for training for each training image, which includes a different number of depth values, in cases where a plurality of pairs of training images and ground truth depth maps are provided.

In another example, the model learning system 100 may specify two or more specific sampling values within a predetermined sampling range. In this case, the model learning system 100 may generate two or more different sparse depth maps for training by extracting the number of depth values corresponding to each of the previously specified two or more sampling values from the plurality of depth values included in the ground truth depth map.

Therefore, the model learning system 100 may generate two or more sparse depth maps for training for each training image, which includes a different number of depth values, in cases where a plurality of pairs of training images and ground truth depth maps are provided.

In another example, the model learning system 100 may specify one of the predetermined plurality of sampling patterns and perform sampling on the ground truth depth map using the specified sampling pattern.

In this case, when a plurality of pairs of training images and ground truth depth maps are provided, the model learning system 100 may apply one randomly specified sampling pattern from the predetermined plurality of sampling patterns to each pair of training image and ground truth depth map, thereby implementing the generation of a sparse depth map for training for each ground truth depth map that is sampled in a different pattern.

In another example, the model learning system 100 may perform sampling on the ground truth depth map multiple times using the predetermined plurality of sampling patterns.

In this case, when a plurality of pairs of training images and ground truth depth maps are provided, the model learning system 100 may apply each of the predetermined plurality of sampling patterns to each pair of training image and ground truth depth map, thereby implementing such that a plurality of sparse depth maps for training, each sampled with a different pattern, are matched to a single training image.

In another example, the model learning system 100 may generate a sparse depth map for training by extracting a plurality of depth values belonging to a predetermined region from the ground truth depth map.

Depending on the embodiment, the predetermined region may be a region belonging to a predetermined circular or polygonal range based on the central pixel of the ground truth depth map, or may be a region belonging to a predetermined circular or polygonal range based on one edge (or one side) of the ground truth depth map.

With reference back to FIG. 5, the model learning system 100 according to the present invention may use a base model pre-provided to predict a depth map from an image, to generate an image feature vector (or first feature) and an initial depth map (or first depth map) corresponding to the training image (S300).

Specifically, the model learning system 100 may use the encoder of the pre-provided base model to generate an image feature vector corresponding to the training image.

With reference to FIG. 7, for example, the model learning system 100 may input a training image 11 into an encoder 21 of a base model 20, which is implemented with an encoder 21-decoder 23 structure and pre-trained to predict a depth map from a given image, to acquire an image feature vector 13 (or image feature).

Further, the model learning system 100 may use the decoder of the base model to generate an initial depth map corresponding to the image feature vector.

With reference to FIG. 8, for example, the model learning system 100 may input the previously acquired image feature vector 13 into the decoder 23, which is implemented to correspond to the encoder 21 of the base model 20, to predict the initial depth map 15 corresponding to the training image.

With reference back to FIG. 5, the model learning system 100 according to the present invention may use a prompt model pre-provided to perform prompt encoding, to generate a final depth map corresponding to the sparse depth map for training, the image feature vector, and the initial depth map (S400).

Specifically, the model learning system 100 may use the encoder of the prompt model pre-provided to perform prompt encoding, to generate a similarity map corresponding to the sparse depth map for training and the image feature vector.

For example, the model learning system 100 may input the sparse depth map for training into the encoder of the prompt model to acquire the prompt embedding vector and the depth map feature vector. Then, using the image feature vector acquired from the encoder of the base model, along with the acquired prompt embedding vector and depth map feature vector, the system 100 may calculate the similarity map.

With reference to FIG. 9, in another example, the model learning system 100 may input the sparse depth map for training 31 into a depth encoder 42, which is included in an encoder 41 of a prompt model 40, to acquire a prompt embedding vector 32 and a depth map feature vector 33.

Subsequently, the model learning system 100 may input the image feature vector 13 acquired from the encoder of the base model 20, along with the previously acquired prompt embedding vector 32 and depth map feature vector 33, into a fusion layer 43 included in the encoder 41 of the prompt model 40 to calculate a similarity map 35.

In another example, the model learning system 100 may use the depth encoder of the prompt model to convert the sparse depth map for training into a prompt embedding vector to be processable by the prompt model, and then compress the previously converted prompt embedding vector to generate the depth map feature vector.

Subsequently, the model learning system 100 may use the fusion layer of the prompt model to fuse the image feature vector with the prompt embedding vector and depth map feature vector, thereby generating a similarity map corresponding to the sparse depth map for training.

Further, the model learning system 100 may use the decoder of the prompt model to generate a final depth map corresponding to the sparse depth map for training, the initial depth map, and the similarity map.

For example, the model learning system 100 may, through the decoder of the prompt model, calculate a first final depth map on the basis of the initial depth map acquired from the decoder of the base model and the sparse depth map for training.

Subsequently, the model learning system 100 may, through the decoder of the prompt model, calculate a second final depth map on the basis of the previously calculated first final depth map and the similarity map.

In this case, the second final depth map may be a final depth map generated through the prompt model for the training image and the sparse depth map for training.

With reference to FIG. 10, in another example, the model learning system 100 may, among a plurality of depth values belonging to the initial depth map 15, extract a plurality of depth values from the initial depth map 15, where their pixel positions correspond to the pixel positions of a plurality of depth values included in the sparse depth map for training 31, and generate an initial depth map 16 that is converted to correspond to the sparse depth map for training 31.

Accordingly, the model learning system 100 may calculate a variable 17 (e.g., first variable and second variable) that minimizes a difference between the previously converted initial depth map 16 and the sparse depth map for training 31, on the basis of a pre-prepared minimum distance calculation algorithm.

Subsequently, the model learning system 100 may apply the previously calculated variable 17 (e.g., at least one of the first variable or the second variable) to the initial depth map 15 output from the initial model to calculate a first final depth map 19.

Accordingly, the model learning system 100 may generate a second final depth map 37 using a similarity map 35, previously calculated by the encoder 41 of the prompt model, and the first final depth map 19 through the decoder 46 of the prompt model.

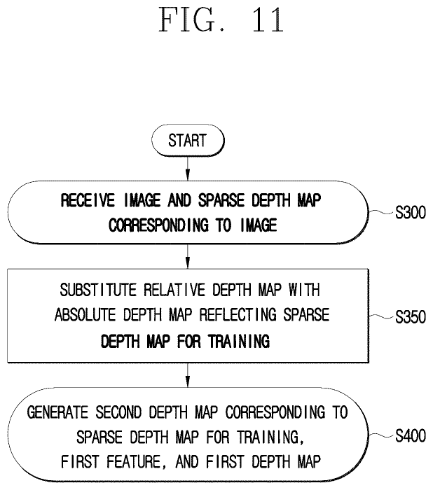

That is, as illustrated in FIG. 11, the model learning system 100 may use the base model to generate an image feature vector (or first feature) and an initial depth map (or first depth map) corresponding to the training image (S300), and substitutes the relative depth map acquired from the base model on the basis of the training image (e.g., initial depth map 15) with an absolute depth map reflecting the sparse depth map for training (e.g., first final depth map 19) (S350), and generates the second final depth map 37 using the previously generated similarity map 35 and the absolute depth map (e.g., first final depth map 19) (S400).

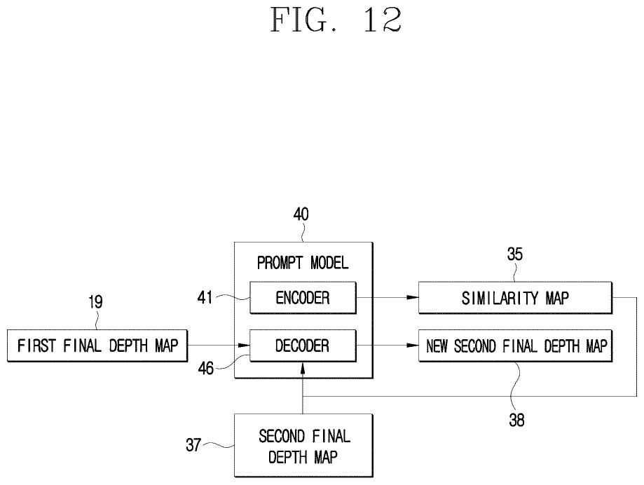

Further, with reference to FIG. 12, the model learning system 100 may generate a new second final depth map 38 by repeatedly performing spatial propagation on the previously generated second final depth map 37 using the similarity map 35 and the first final depth map 19.

In this case, repeatedly performing spatial propagation may involve generating a new second final depth map 38 using the similarity map 35, the first final depth map 19, and the previously generated second final depth map 37, and such spatial propagation may be repeatedly performed until a predetermined condition is satisfied.

In an embodiment, the predetermined condition may be the number of times spatial propagation is performed. In another embodiment, the predetermined condition may be defined as a threshold for the rate of change between the previously generated second final depth map 37 and the new second final depth map 38.

With reference back to FIG. 5, the model learning system 100 according to the present invention may train the prompt model so that the final depth map simulates the ground truth depth map (S500).

Specifically, the model learning system 100 may calculate a loss of the base model for the ground truth depth map as well as a loss of the prompt model, and calculate a final loss on the basis of both the loss of the base model and the loss of the prompt model.

With reference to FIG. 13, for example, the model learning system 100 may calculate a loss 49 (or first loss) of the prompt model on the basis of a final depth map 39 (e.g., second final depth map, or second depth map) generated by a prompt model 40 and a ground truth depth map 12, and may calculate a scale-invariant loss 29 (or second loss) for the base model on the basis of the initial depth map 15 generated by the base model 20 and the ground truth depth map 12.

Accordingly, the model learning system 100 may calculate a loss 51 (or third loss) of the depth map inference model using the loss 49 of the prompt model and the scale-invariant loss 29 for the base model.

Further, the model learning system 100 may train the prompt model to minimize the previously calculated loss of the depth map inference model.

For example, the model learning system 100 may compare the final depth map generated on the basis of a specific training image and sparse depth map for training with the ground truth depth map. With the comparison result, the model learning system 100 may train the depth map inference model by correcting the parameters of the prompt model to minimize the previously calculated loss of the prompt model.

In this case, the model learning system 100 may use the previously trained depth map inference model to regenerate the final depth map on the basis of a training image and sparse depth map for training different from the specific training image and sparse depth map for training. The model learning system 100 may then compare the generated final depth map with the ground truth depth map and, on the basis of the comparison result, repeat the process of correcting the parameters of the prompt model to minimize the previously calculated loss of the prompt model, thereby training the depth map inference model.

In another example, the model learning system 100 may train the depth map inference model by repeating the process of correcting the parameters of the prompt model to minimize the loss of the depth map inference model based on the loss of the prompt model and the scale-invariant loss of the base model.

In this case, the model learning system 100 may repeat the training of the depth map inference model until the loss of the depth map inference model satisfies a predetermined condition. In this case, depending on the embodiment, the predetermined condition may be variously defined, such as a certain number of iterations or a threshold value for the loss of the depth map inference model.

With the configuration as described above, the model learning system 100 according to the present invention may generate a sparse depth map for training with a random pattern from a dense depth map, and use this to train a depth map inference model that includes a prompt encoder. This allows the system to overcome biases caused by insufficient training data, biases due to patterns in the sparse depth maps measured by sensors, and biases due to measurement range limitations of the sensors, thereby implementing a model capable of sensor-agnostic depth map inference.

That is, the model learning system 100 according to the present invention extracts features of an image through the base model included in the depth map inference model, fuses the sparse depth map with the image features through the prompt model included in the depth map inference model, and trains the depth map inference model to infer a depth map on the basis of this fusion. Therefore, the system may infer a depth map in which both the actual spatial shapes and the depth information measured by the sensor are considered together.

Meanwhile, with reference to FIG. 14, the depth map inference system 200 according to the present invention may receive an image and a sparse depth map corresponding to the image (S600).

For example, the depth map inference system 200 may receive an image and a sparse depth map that are captured based on a camera provided with a depth sensor.

In this case, the sparse depth map may include a plurality of depth values measured in different patterns, depending on the type and form of the depth sensor.

In addition, the depth map inference system 200 according to the present invention may use a base model pre-provided to predict a depth map from an image, to generate an image feature vector and an initial depth map corresponding to the image (S700). The depth map inference system 200 may use a prompt model pre-trained to perform prompt encoding, to generate a final depth map (or second depth map) corresponding to the sparse depth map, image feature vector, and initial depth map (S800). Then, as a depth map corresponding to the previously received image, the depth map inference system 200 may provide the previously generated final depth map (S900).

With reference to FIG. 15, for example, the depth map inference system 200 may use the encoder of a base model 81 to generate an image feature vector 63 corresponding to an image 61, and use the decoder of the base model 81 to generate an initial depth map 65 corresponding to the image feature vector 63.

In addition, the depth map inference system 200 may use the encoder of a prompt model 86 to generate a prompt embedding vector 73 and a depth map feature vector 75 corresponding to the sparse depth map 71. Then, using the image feature vector 63 acquired from the encoder of the base model 81, along with the prompt embedding vector 73 and the depth map feature vector 75, the depth map inference system 200 may generate a similarity map.

Subsequently, the depth map inference system 200 may use the decoder of the prompt model 86 to generate a final depth map 91 corresponding to the sparse depth map 71, the initial depth map 65, and the similarity map.

With the configuration as described above, the depth map inference system 200 according to the present invention may predict a depth map corresponding to an image and a sparse depth map captured based on various types of sensors, using the depth map inference model trained to be independent of the type of sensor.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A model learning method capable of sensor-agnostic depth map inference, comprising:
receiving a training image and a ground truth depth map corresponding to the training image;
generating, using the ground truth depth map, a sparse depth map for training corresponding to the ground truth depth map;
generating, using a first model, pre-provided to predict a depth map from an image, a first feature and a first depth map corresponding to the training image;
substituting the first depth map, which is a relative depth map acquired from the first model on the basis of the training image, with an absolute depth map reflecting the sparse depth map for training;
generating, using a second model, pre-provided to perform prompt encoding, a second depth map corresponding to the sparse depth map for training, the first feature, and the substituted first depth map; and
training the second model so that the second depth map simulates the ground truth depth map.

2. The model learning method of claim 1, wherein the generating of the second depth map includes:
converting, using a depth encoder of the second model, the sparse depth map for training into a second feature to be processable by the second model; and
compressing the converted second feature to generate a third feature.

3. The model learning method of claim 2, wherein the generating of the second depth map further includes:
generating, using a fusion layer of the second model to fuse the first feature with the second feature and the third feature, a similarity map corresponding to the sparse depth map for training; and
generating, using a decoder of the second model, the second depth map corresponding to the sparse depth map for training, the substituted first depth map, and the similarity map.

4. The model learning method of claim 1, wherein the training of the second model includes:
calculating a loss of the second model on the basis of the second depth map and the ground truth depth map;
calculating a scale-invariant loss for the first model on the basis of the first depth map and the ground truth depth map;
calculating, using the loss of the second model and the scale-invariant loss of the first model, a loss of a depth map inference model that includes the first model and the second model; and
training the second model so that the calculated loss of the depth map inference model is minimized.

5. The model learning method of claim 1, wherein, in the generating of the sparse depth map for training, the sparse depth map for training is generated by extracting a predetermined number of depth values from the ground truth depth map through sampling of the ground truth depth map.

6. A model learning system capable of sensor-agnostic depth map inference, comprising:
a communication unit configured to receive a training image and a ground truth depth map corresponding to the training image; and
a control unit configured to train a depth map inference model using the training image and the ground truth depth map,
wherein the depth map inference model includes a first model and a second model, and
wherein the control unit is configured to:
generate, using the ground truth depth map, a sparse depth map for training corresponding to the ground truth depth map,
generate, using the first model, pre-provided to predict a depth map from an image, a first feature and a first depth map corresponding to the training image,
substitute the first depth map, which is a relative depth map acquired from the first model on the basis of the training image, with an absolute depth map reflecting the sparse depth map for training,
generate, using the second model, pre-provided to perform prompt encoding, a second depth map corresponding to the sparse depth map for training, the first feature, and the substituted first depth map, and
train the second model so that the second depth map simulates the ground truth depth map.

7. A program stored on a computer-readable recording medium, and executed by one or more processes in an electronic device, the program comprising instructions to allow the program to perform:
receiving a training image and a ground truth depth map corresponding to the training image;
generating, using the ground truth depth map, a sparse depth map for training corresponding to the ground truth depth map;
generating, using a first model, pre-provided to predict a depth map from an image, a first feature and a first depth map corresponding to the training image;
substituting the first depth map, which is a relative depth map acquired from the first model on the basis of the training image, with an absolute depth map reflecting the sparse depth map for training;
generating, using a second model, pre-provided to perform prompt encoding, a second depth map corresponding to the sparse depth map for training, the first feature, and the substituted first depth map; and
training the second model so that the second depth map simulates the ground truth depth map.

8. A depth map inference method using a depth map inference model that includes a first model and a second model, the depth map inference method comprising:
receiving an image and a sparse depth map corresponding to the image;
generating, using the first model, pre-provided to predict a depth map from an image, a first feature and a first depth map corresponding to the image;
substituting the first depth map, which is a relative depth map acquired from the first model on the basis of the image, with an absolute depth map reflecting the sparse depth map;
generating, using the second model, pre-trained to perform prompt encoding, a second depth map corresponding to the sparse depth map, the first feature, and the substituted first depth map; and
providing the second depth map as a depth map corresponding to the image.

9. A depth map inference system, comprising:
an input unit configured to receive an image and a sparse depth map corresponding to the image; and
a control unit configured to generate a depth map corresponding to the image and the sparse depth map using a pre-trained depth map inference model,
wherein the depth map inference model includes a first model and a second model, and
wherein the control unit is configured to:
generate, using the first model, pre-provided to predict a depth map from the image, a first feature and a first depth map corresponding to the image,
substitute the first depth map, which is a relative depth map acquired from the first model on the basis of the image, with an absolute depth map reflecting the sparse depth map,
generate, using the second model, pre-trained to perform prompt encoding, a second depth map corresponding to the sparse depth map, the first feature, and the substituted first depth map, and
provide the second depth map as the depth map corresponding to the image.

10. A program stored on a computer-readable recording medium, and executed by one or more processes in an electronic device, the program comprising instructions to allow the program, in a depth map inference method using a depth map inference model that includes a first model and a second model, to perform:
receiving an image and a sparse depth map corresponding to the image;
generating, using the first model, pre-provided to predict a depth map from an image, a first feature and a first depth map corresponding to the image;
substituting the first depth map, which is a relative depth map acquired from the first model on the basis of the image, with an absolute depth map reflecting the sparse depth map;
generating, using the second model, pre-trained to perform prompt encoding, a second depth map corresponding to the sparse depth map, the first feature, and the substituted first depth map; and
providing the second depth map as a depth map corresponding to the image.
